(19) United States
(12) Patent Application Publication
(10) Pub. No.: US 2002/0184261 A1
(43) Pub. Date: Dec. 5, 2002

(54) Process of inputting and outputting a display table derived from a worksheet and data storage media programmed to perform the same

(76) Inventor: Manki Yamane, Fukuyama (JP)

Correspondence Address: KENNETH A. BENSON, PACIFIC RING SERVICES, INC., 1143 CHRISTINA MILL DRIVE, NEWARK, DE, 19711, US

(21) Appl. No.: 10/057,119

(22) Filed: Oct. 22, 2001

(30) Foreign Application Priority Data
Oct. 27, 2000 (JP) 2000-369296

(51) Int. Cl. G06F 15/00

(52) U.S. Cl. 707/503; 707/500

(57) ABSTRACT

[Problem the Present Invention Intends to Solve] The object of the present invention is to resolve the problem by providing a process of modifying a layout of worksheet's cells having formulas and display attributes to/from a display format based on given display layout defining data, and by printing a journal in the modified (display) format, while maintaining the original formulas and display attributes.

[Means to Resolve the Problem] CPU 2 is a central computation system for controlling each of the components in computer system 1, and reads out its system program stored in memory device 10 and develops the program into a storage region of worksheet calculation processing unit 4, layout conversion processing unit 6, and a storing region of layout setting unit 11. When one selects a data file using input apparatus 3, the data file is read from memory device 10 and is stored in worksheet calculation data unit 5. display layout defining data (defining file) written in the data file [are thus read] from memory device 10 and stored in layout defining data unit 7. At the same time, data cells in worksheet calculation data unit 5 are laid out via layout conversion processing unit 6, and are displayed on display apparatus 8, or printed through printer 9. The cell addresses of new display data entered [into a display table] by operating input apparatus 3 are converted to worksheet calculation data cell addresses. The converted data are stored in worksheet calculation data unit 5 via worksheet calculation processing unit 4. Through the above subroutine, the data entered in a data table having multiple cells are stored in a worksheet calculation cell address by the cell address conversion subroutine in layout conversion processing unit 6. The relationship between calculation cell addresses expressed by mathematical formulas is always consistent, and a worksheet data table is thus modified into a display table for input and output by simply changing the display layout defining data or defining file.

This application claims priority of Japanese Patent Application No. 2000-369296 filed Oct. 27, 2000

### DETAILED DESCRIPTION OF THE INVENTION

1. Technical Field

The present invention relates to a method of (1) calculating a display layout for data fields called “cells” written with formulas and display attributes on a worksheet, (2) inputting/outputting the resulted display layout, and (3) printing a journal while maintaining the original formulas and display attributes. It also relates to a data storage medium programmed to perform the function.

2. Related Art

Conventionally, a handy software program for worksheet calculations has been available. In this type of program, data including formulas are entered and saved in a specific cell address expressed by the X (column) and Y (row) coordinate system for displaying and printing the result of the calculation. Ways to input and display data must be in accordance with the rules as set forth in the XY coordinates system of the original data. In other words, to conventionally create a comparison table in which the column D cells are arranged below column A cells, one must create a separate worksheet on a screen, and enter cell references to display the target source data.

### Problems the Invention Intends to Resolve

The conventional worksheet program was inefficient for entering, calculating, displaying, and printing a large volume of data. It has been impossible to modify a not-for-display worksheet to/from a display table, while maintaining the original formulas and display attributes.

The object of the present invention is to resolve the problem by providing a process of modifying a layout of worksheet's cells having formulas and display attributes to/from a display format based on given display layout defining data, and by printing a journal in the modified (display) format, while maintaining the original formulas and display attributes.

### Means to Resolve the Problem

To resolve the inefficiency, a worksheet data [display] layout is set up by display layout defining data in the present invention. The display layout defining data are created in a display table format and comprise:

layout information for defining worksheet's column address, at which the source data are calculated, and cell address, at which the source data are displayed and printed; and

header and footer information, which defines page settings required for printing.

The display layout defining data define the following default values in layout information:

column width;

row height;

display attribute (e.g. character font, character size, character color, background color, number expressing, line type, line color.)

The invention according to claim 1, a process of inputting/outputting a display table derived from worksheet cells having formulas and display attributes by repeatedly developing columns of the worksheet cells into rows [of the display table]; and inputting/outputting the data cells in a modified format based on previously-set layout information in display layout defining data file. When new data are entered into a display table of multiple cells, the entered data have a display cell address, which are then matched with the worksheet's column address defined by the layout information, and converted back into the original worksheet cell addresses for storage. In this way, new data can be input into a display table and the resulting table can be output while maintaining the mathematical relationship between worksheet's cell address and display table's cell address together with display attributes.

Another invention according to claim 2 provides a process of outputting a journal [of a display table] derived from worksheet cells having formulas and display attributes by a printer. The steps comprise (1) calculating a printable area, excluding the header and footer defined in the display layout defining data, based on commands entered for paper size, paper orientation, and margins; (2) adjusting header information in a display layout defining data file; (3) repeatedly developing the worksheet's column cells into rows of a printable region as defined in the layout information in the display layout defining data [file]; (4) inserting a blank column when the developed region is narrower than the printable area defined by the layout information; and (5) adjusting a footer as defined in the footer information in the display layout defining data file.

Yet another invention according to claim 3 is a process of inputting/outputting display data derived from a worksheet layout for display input/output as set forth in claim 1 or a process of outputting a journal through a printer as set forth in claim 2 by changing the display layout defining data or defining files so as to reflect the modified data onto a table of multiple display cells while maintaining the original formulas and display attributes. One can select a different format having a different column width, a different default value in the display layout defining file, a different row height and display attribute, in the display layout information in the display layout defining data [file] such that one can see a desirable display table of multiple cells to be printed later.

Yet another invention according to claim 4 is a method of inputting/outputting display data as set forth in claim 1 or a process of outputting a journal of the display table derived from a worksheet by a printer as set forth in claim 2 by entering a command into a plurality of display table cells for changing column width, row height, and data cells' display attributes on cells while maintaining the original formulas and display attributes.

### EMBODIMENT

The present invention is described in detail with reference to the drawings herein. FIGS. 1-18 are diagrams showing an embodiment of a computer system to which the present invention is applied. First of all, its configuration is described. FIG. 1 is a diagram showing major blocks of the computer system 1 of this embodiment. In FIG. 1, computer system 1 comprises CPU 2; input apparatus 3; worksheet calculation processing unit 4; worksheet calculation data unit 5; layout conversion unit 6; display apparatus 8; printer 9; memory device 10; and layout setting unit 11. Each of the blocks are connected to each other via bus 12.

CPU 2 is a central computation system for controlling each of the components in computer system 1, and reads out its system program stored in memory device 10 and develops the program into a storage region of worksheet calculation processing unit 4, layout conversion processing unit 6, and a storing region of layout setting unit 11. When one selects a data file using input apparatus 3, the data file is read from memory device 10 and is stored in worksheet calculation data unit 5. display layout defining data (hereafter referred to as “defining file”) written in the data file are thus read from memory device 10 and stored in layout defining data unit 7. At the same time, data cells in worksheet calculation data unit 5 are laid out via layout conversion processing unit 6, and are displayed on display apparatus 8, or printed through printer 9. The cell addresses of new display data entered [into a display table] by operating input apparatus 3 is converted to worksheet calculation data cell addresses. The converted data are stored in worksheet calculation data unit 5 via worksheet calculation processing unit 4. The converted data are also saved into memory device 10 as required.

Input apparatus 3 comprises a keyboard having cursor keys, numerical keys, and various function keys; and a pointing device (e.g. mouse); and outputs a signal informing key activation or a mouse's pointing location to CPU 2.

The worksheet calculation program is stored in a storage region in worksheet calculation processing unit 4 when CPU 2 executes a system program. The table data on a screen are stored or developed in a memory region in worksheet calculation data unit 5 during execution of the layout conversion program.

Display cell addresses are converted into worksheet cell addresses in a subroutine stored in a region in layout conversion processing unit 6 as programmed in display layout defining data unit 7. display layout defining data (defining file) are developed in a memory region in layout defining data unit 7 when layout conversion processing unit 6 executes conversion of the original layout.

Display layout data and the like are input into CPU 2 for showing on display apparatus 8 comprising cathode-ray tube (CRT), and output into printer 9 to print the table on a screen onto a given recording paper.

A worksheet calculation program is stored and data field are provided in layout setting unit 11 so as to create display layout defining data 11a as shown in FIG. 4. One may utilize a commercial worksheet calculation program for creating display layout defining data 11a, but the worksheet calculation program is provided in computer system 1 for convenience in this embodiment.

display layout defining data 11a comprise layout information 11c and header information 11b and footer information 11d wherein display layout information 11c defines column addresses in a worksheet and cell addresses in a display and print format. When the number of rows is entered, the storage region and the data region are divided by the number of rows entered. In FIG. 4, for example, there are 5 rows for header information 11b; 2 rows for [display] layout information 11c; 4 rows for footer information 11d. In display layout information 11c, some cells are merged as required, display attributes are set up, and column addresses are selected from a drop-down list. In order to avoid creating overlapped column addresses on a worksheet, layout setting unit 11 is programmed such that the drop down list shows unassigned worksheet column addresses only. Display layout setting unit 11 utilizes three counters: a column width change counter, a row height change counter, and a cell change counter. The column width change counter recognizes when column width in display layout defining data 11a are changed; the row height change counter recognizes when the row height in the display layout information 11c is changed; and the cell change counter recognizes when cells in the [display] layout information 11c are changed. Both the change counter value and the display table (layout file) data are saved as display layout defining data 11a. In FIG. 4, a “comma at every three digits” attribute (not shown) is entered in columns F, B, and C and this information is saved in display layout information 11c file; a “fine line” attribute is entered in columns D, G, F, B, and C.

Next, how computer system 1 executes this embodiment is described herein. FIG. 5 shows a flow chart showing the steps for setting up display layout defining data required for laying out worksheet data [on a screen.]

As the system program starts, the data file (see FIG. 2), read out from memory device 10, is developed into worksheet calculation data unit 5. If the display layout defining data are not set up in the initial stage, the data file does not have a file name, as a result, the display layout defining data cannot be developed in display layout defining data unit 7. Cell addresses of arguments at the time of calling cannot be converted by the subroutine in layout conversion processing unit 6 (described later) and are returned to worksheet calculation processing unit 4. As a result, the screen shows cells as illustrated in (FIG. 3), in the same manner as a conventional worksheet calculation program.

To set up display layout defining data in worksheet to be calculated, one selects display layout defining data (defining file) created in layout setting unit 11. The “Sn” notations (where n=1, 2, 3, etc.) are step numbers. First, the presence of display layout defining data 11a of FIG. 4 in memory device 10 is checked (step S1). If display layout defining data 11a are present, they are developed in display layout defining data unit 7 in step 2, then the following process steps are executed in the data field in worksheet calculation data unit 5. The absence of display layout defining data 11a in step S1 terminates the process.

The column width data field in worksheet calculation data unit 5 is cleared (step S3), and the number of columns defined by layout information 11c of display layout defining data 11a are computed (step S4). The column width value in display layout defining data 11a are written as many times as computed [in step S4] in the column width data region in worksheet calculation data unit 5 (step S5).

The row height data region in worksheet calculation data unit 5 is cleared (step S6), and the total row height value in layout information 11c in display layout defining data 11a are written over the row height default data region (step S7).

In step S8, one inputs his/her decision on whether to maintain cell's display attributes. If cell's display attributes are not maintained, the execution goes to step S9. This is the step in which display attributes of a worksheet column address defined by [display] layout information 11c in display layout defining data 11a are repeatedly written over the cell's display attribute data region and default data region in the table data which corresponds to column addresses [of the same data] developed into worksheet calculation data unit 5. If the cell's display attributes are to be maintained, the process goes to step S10, in which only line information (e.g. line type, line color) is repeatedly written over the display attribute data region and default data region (column display attribute) in the table data which corresponds to column addresses [of the same data] developed into worksheet calculation data unit 5.

The display layout defining data are thus set up for a worksheet, which is further processed by a display output program described later, and appears on display apparatus 8 in the format shown in FIG. 6. FIG. 6 is the table obtained when a “no display attribute” command is input from input apparatus 3.

The above process works even if one inputs a new command for changing the display layout defining file created in layout setting unit 11.

When one operates input apparatus 3 and enters a “save” command for saving table data, the display layout defining data 11a developed into layout defining data unit 7 (not illustrated) are saved, followed by saving of the original values of the table data in worksheet data unit 5. Note that the display layout defining data 11a comprise a file name, change counter values showing column width, row height, cells, and values in cells in layout information 11c.

FIG. 7 is a flow chart showing the steps required for reading the table data into a memory device 10 for which the display layout defining data are set up according to the above process steps.

When a “data file” command is input from input apparatus, the data file as shown in FIG. 2 is developed into worksheet calculation data unit 5, display layout defining data 11a (defining file) as shown in FIG. 4 are read from memory device 10, and saved in display layout defining data unit 7 by the same file name as the above data file (step S11).

The column width change counter values in the data file and those developed from display layout defining data 11a into display layout defining data unit 7, are compared with each other (step S12). If both values are the same, the execution goes to step S16. If two values are different from each other, the data field defining the column width in worksheet data unit 5 is cleared (step S13), the number of columns defined by layout information 11c of display layout defining data 11a are computed (step S14). The column width value of display layout defining data 11a is written over the column width data field in worksheet calculation data unit 5 as many times as the number of columns (step S15).

Row height change counter values in the data file and those developed from display layout defining data 11a into display layout defining data unit 7, are compared with each other (step S16). If both values are the same, the execution goes to step S19. If two values are different from each other, the data field defining the row height for worksheet data unit 5 is cleared (step S17). Row height values defined by layout information 11c of display layout defining data 11a are added up and written over the data region defining a default value (step S18).

The cell change counter value, showing a change in cell in the data file and that developed from display layout defining data 11a into display layout defining data unit 7, are compared with each other (step S19). If both values are the same, the execution ends. If two values are different from each other, the execution goes to step S20, and the worksheet calculation column address and the column address in the data file previously used for display and saved are compared with each other. If the two column addresses are different from each other, display attributes of a specific cell in [display] layout information 11c are repeatedly written over the display attribute data region corresponding to a specific column address (column's display attribute) in table data developed into worksheet calculation data unit 5, and the data region defined by the cell's default value (step S21). If the two column addresses are the same, the display attribute in layout information 11c in display layout defining data 11a and that in the data file are compared with each other (step S22). If the two attributes are the same the execution is terminated. If the two attributes are different from each other, the changed attribute is found (step S23) and is repeatedly written in the data region defined by an attribute in a specific column address in table data developed into worksheet data calculation data unit 5, and the data region defined by the cell's default value (step S24).

In summary, a display data table [developed into worksheet data calculation unit 5] is changed according to display layout defining data 11a in layout setting unit 11 and is converted onto a table intended for display, which is further input [into memory device 10]. For example, when one changes display layout defining data 11a shown in FIG. 4 into that shown in FIG. 8, display apparatus 8 will display the data in the format shown in FIG. 9 by executing the display output processing described later. The grid lines at the bottom of the cells in the D, G, F, B, and C rows are fine lines (not shown in FIG. 8).

Steps required for executing the display output processing are described herein with reference to the flow chart shown in FIG. 10.

When the original data region is too large to be displayed on a screen, one needs to scroll horizontally and vertically in a worksheet calculation program of conventional technology. The worksheet calculation program is designed in such a way that the address of the upper left cell on the screen is regarded as an origin for calculating row height and column width to be viewed on a screen, and the same process is used for the display output processing of the data viewed on a screen. The cells to be laid out have addresses comprising row address, column address, and division point at which a row is divided. The process step begins with step S25, and the display start row (upper left cell's row address) and display start column (upper left cell's column address) are obtained from the upper left cell address viewed on the screen.

Base coordinates are obtained for the upper left cell on the screen (step S26). The last display row is counted on the increment of row height starting from the display-start row in the base coordinate system; the last display column is counted on the increment of column width starting from the display-start row in the base coordinate system (step S27).

The display-start row is written into a target display row, and the Y-value in the base coordinate system is written over the Y-value in the display coordinate (step S28). The display-start column is written into target display column, and the X-value in the base coordinate system is written over the X-value in the calculated base coordinate system (step S29).

Computation [required for a new format] is executed by passing the target row, target column, Y-value, X-value, and graphic object (argument) for display apparatus 8 onto the cells' graphic object process subroutine as described in the flow chart shown in FIG. 11.

FIG. 11 shows a subroutine for assigning arguments to cells to be executed by display apparatus 8 or printer 9 based on the arguments' graphic object information. First of all, whether display layout defining data 11a are developed in display layout defining data unit 7 is checked. If display layout defining data 11a are developed into layout defining unit 7, the execution goes to step S38, in which the number of divisions is overwritten with the number of rows counted in [display] layout information 11c. If display layout defining data 11a are not developed, the number of divisions is overwritten with “1” (step S39).

Then, “1” is overwritten with a division point (step S40), cell's graphic object region is computed based on X-value, Y-value, row height, column width, and graphic object information (step S41).

Step S42 checks if the resulted graphical object region is valid. If the cell is not valid due to a cell's being merged with another cell and already has a graphical object therein, the execution goes to step S47.

In step S43, arguments expressing a cell address (e.g. target row, target column and division point) is input into a cell address conversion subroutine in layout conversion processing unit 6 and executed therein, then the execution returns to the flow chart shown in FIG. 12.

FIG. 12 is a subroutine in which a display cell address is converted to a worksheet calculation cell address. In step S49, a return value row address in the subroutine is overwritten with a target row. Step S50 is the step for checking if display layout defining data 11a are developed into display layout defining data unit 7. If display layout defining data 11a are not developed therein, a return value column address in the subroutine is overwritten with a target column (step S51), then the subroutine is terminated.

A cell defined by the target column and the division point is picked up from layout information 11c in display layout defining data 11a (step S52). Whether the worksheet calculation column address is specified for the selected cell is checked (step S53). If the worksheet column address is specified, a column address in the subroutine is overwritten with the worksheet column address of the picked cell (step S54). If the worksheet column address is not specified, the return column address in the subroutine is overwritten with “−1” (step S55), and the subroutine is terminated.

Next, the execution returns to steps in FIG. 11, and the presence of a return value column address in the subroutine is checked (step S44). If there is a worksheet calculation cell, its cell value and display attribute are graphically drawn (step S45). If there is no worksheet calculation cell, its display attribute is drawn based on the target column and division point in layout information 11c in display layout defining data 11a (step S46). It is necessary to compute line information (line type, line color) by relating its display attributes with those of adjacent cells (not illustrated) when drawing borders. If the drawing information is intended for use in display apparatus 8 and no line information is set up for any cells, borders are drawn according to the default border information defined by a worksheet calculation.

Next, the division point number and the number of divisions specified for a row are compared with each other (step S47). If the two numbers are the same, the subroutine is terminated. If the two numbers are different, the division point number is incremented (step S48), and the process steps S41-S48 are repeatedly executed until the row division number reaches the division point number.

The next step goes back to the flow chart shown in FIG. 10, in which numbers in the target column and the last-display column are compared. If the two numbers are the same, the execution goes to step S34. If the two numbers are different, the column width is added to the X value (step S32), and the target column is incremented (step S33). This process is repeatedly executed until the target column number reaches the last-display column number.

Then, numbers in the target row and the last-display row are compared in step S34. If the two numbers are the same, the execution is terminated. If the two numbers are different, the row height is added to the Y-value in step S35, and the target row is incremented in step S36. Steps S29-S36 are repeatedly executed until the target row number reaches the last-display row number.

The data file shown in FIG. 2 is processed by the routine described above and the format shown in FIGS. 3, 6, and 9 are displayed on display apparatus 8.

Next, a screen input process is described based on the flow chart as shown in FIG. 13.

When input apparatus 3 is operated to enter data into the table having multiple cells to appear on display apparatus 8, the above display output process is executed to compute a target cell address (row address, column address, and division point), based on row height and column width, utilizing the managed upper left cell address (step S56).

Next, arguments representing the cell address ([a combination of] row address, column address and division point) are passed onto a cell address conversion subroutine in layout conversion processor 6 (S57), and the flow chart routine shown in FIG. 12 is executed.

The presence of the return value column address in the above subroutine is checked (S58). If a worksheet calculation cell is not present, the subroutine is terminated. If a worksheet calculation cell is present, a value is input into the worksheet calculation cell (S59), and the worksheet cell data are calculated reflecting any change entered therein (S60).

Through the above subroutine, the data entered in a data table having multiple cells are stored in a worksheet calculation cell address by the cell address conversion subroutine in layout conversion processing unit 6. As a result, the relationship between calculation cell addresses expressed by mathematical formulas is always consistent.

For example, assume that the data file as shown in FIG. 2 is changed into a data table formatted as shown in FIG. 6. If one inputs “9999” to the cell showing “200” in the new table, the calculated cell addresses will be “2” for the row address, “4” for the column address, and “1” for the division point, and the worksheet calculation cell whose row address is “2” and column address is “6” is overwritten with the converted values. The table created by the above display output process appears in the display format as shown in FIG. 14 on display apparatus 8.

The above routine can be applied to the case in which cell's display attributes are changed. Also, if one wants to change column width or row height of multiple cells in a table (not shown) appearing on display apparatus 8, one may operate input apparatus 3 to enter a new value into the data region defining the column width or row height in worksheet calculation data unit 5.

Next, journal output processing is described based on the flow chart as shown in FIG. 15.

When a “print” command is input from input apparatus 3, and whether the print data are present on a data table developed into the data region in worksheet calculation data unit 5 is checked (S61). If print data are present, the following routine is executed. If print data are not present, the execution is terminated.

The last row is obtained for the table data developed in worksheet calculation data unit 5 (step S62). An appropriate print area for the paper is calculated based on paper size, print orientation, and margins (step S63), and the print-start coordinates are overwritten with the calculated upper left coordinates of the print area (step S64).

Next, whether display layout defining data 11a are developed in display layout defining data unit 7 is checked (S65). If display layout defining data 11a are not developed therein, the printable area is overwritten with the calculated print area on the data table (S66), and the last column in the data table developed into worksheet calculation data unit 5 is calculated (step S67). If display layout defining data 11a are developed therein, the printable area in the data table is overwritten with the region defined by excluding header information 11b and footer information 11d from the calculated print area (step S68), and the last column in the data table is calculated based on the number of columns defined by display layout defining data 11a (step S69).

Then, the print-start row and print-start column are overwritten with “1” to initialize the print-start point (step S 70). The last print row is calculated for the printable region in a data table based on the row height originating from the print start row, and the last print column is calculated based on the column width originating the print-start column (step S71). The number of blank rows that can possibly be arranged in the region, excluding the printable region through the last print row on a table, is calculated based on the default row height of the data table (step S72).

Next, the print start row, print start column, last print row, last print column, and the print start coordinates in the form of arguments are passed onto the print process subroutine (step S73), then the flow chart shown in FIG. 16 is executed.

FIG. 16 shows a subroutine by which data table is printed by printer 9. First, a target print row is overwritten with the print-start row and the Y-value of the print coordinates is overwritten with the Y-value of the print-start coordinates (step S76).

display layout defining data 11a are developed into layout defining data unit 7, and whether header information 11b is defined is checked (step S77). If heater information 11b is not defined therein, the execution goes to step S80. If header information 11b is defined, header information 11b is printed based on the print-start column, last print column, and print-start coordinates (step S78), and the total row height of header information 11b is added to the Y-value (step S79).

Next, the target print column is overwritten with the print start column, and the X-value of the print coordinates is overwritten with the X-value of the print start coordinates (step S80). The target row, target column, X-value, Y-value, and graphic object information for printer 9 are passed onto cells' graphic object process subroutine in the form of arguments (step S81), then the previously described flow chart as shown in FIG. 11 is executed.

Then, the target column and the last print column are compared to each other (step S82). If the two numbers are the same, step S85 is executed. If the two numbers are different, the column width is added to the X-value (step S83), and the target column is incremented (S84), followed by repeating the routine from S81-S84 until the target column reaches the last print column.

Then, the target row and last print row are compared to each other (step S85). If the two numbers are the same, step S88 is executed, that is, the flow chart shown in FIG. 17 is executed. If the two numbers are different, the row height is added to the Y-value (step S86), and the target row is incremented (step S87), and the routine from S80-S87 is repeatedly executed until the target row reaches the last print row.

Next, the number of blank rows is checked (step S88). If the number of blank rows is “0”, the target row is overwritten with “1” (step S89), and blank rows are printed based on the print-start column, last print column, Y-value, and print-start X-value (step S90). Then, the number of target rows and the number of blank rows are compared to each other (step S91). If the two numbers are the same, the execution goes to step S94. If the two numbers are different, a default row height in a data table is added to the Y-value (step S92), and the target row is incremented (S93), followed by repeated execution of S90-S93 until the number of target rows reach the number of blank rows.

Next, display layout defining data 11a are developed in display layout defining data unit 7, and whether footer information 11d is defined is checked (step S94). If footer information 11d is not defined, the execution of the subroutine is terminated. If footer information 11d is defined, footer information 11d is printed based on the print start column, last print column, Y-value, and print start X-value (step S95); then execution of the subroutine is terminated.

The execution returns to the flow chart as shown in FIG. 15, in which comparison is made between the last print row and the data last row, and between the last print column and the data last column to see if the next page is present (S74). If the next page is absent, the execution is terminated. If the next page is present, the print-start row and the print-start column are calculated based on the last print row and the last print column (step S75), followed by repeated the execution of steps S71-S75 until the last print row ,matches the last data row, and the last print column matches the last print column.

According to the above process, when a “print” command is entered into a data table displayed in the format as shown in FIG. 6, printer 9 prints out the data in the format as shown in FIG. 18.

As described above, in processing formulas and display attributes written in worksheet cells, the computer system 1 of this invention is able to layout the table data in a different format based on previously-set display layout defining data while maintaining the original formulas and attributes, and provides a method of inputting/outputting the data on a screen and a journal paper.

### EFFECTS OF THE INVENTION

According to the method of inputting/outputting worksheet cells in a modified format of the present invention, a data table formatted in a layout different from the original worksheet can be viewed on a screen and a journal of the modified layout can be obtained utilizing previously-set display layout defining data. In the present invention, the original formulas and display attributes are always maintained. It thus provides an efficient information management system for large-scale data processing involving a worksheet. One can thus input/output the data in a format that best suits his/her business purpose.

### BRIEF DESCRIPTION OF THE DRAWINGS

FIG. 1 is a block diagram showing a major configuration of the computer system to which the present invention is applied.

FIG. 2 is a diagram showing how table data, stored in worksheet data unit 5 of FIG. 1, are constructed.

FIG. 3 is a diagram showing how the table data of FIG. 2 appears on display apparatus 8 in the initial state, when the display layout defining data for the table layout of FIG. 2 are not set.

FIG. 4 is a diagram showing how the display layout defining data, for storing in display layout defining data unit 7 of FIG. 1, are configured.

FIG. 5 is a flow chart showing the process, in which display layout defining data for the table layout of worksheet data unit 5 of FIG. 1 are set.

FIG. 6 is a diagram showing how the table data of FIG. 2 appears on display apparatus 8 when the display layout defining data for the table layout of FIG. 4 are set.

FIG. 7 is a flow chart showing the process in which the table data, to which the display layout defining data for layout are set in worksheet calculation data unit 5 of FIG. 1, are read [into memory device 10]

FIG. 8 is a diagram showing how display layout defining data are configured when the display layout defining data of FIG. 4 are changed by layout setting unit 11.

FIG. 9 is a diagram showing how the table data of FIG. 2 appear on display apparatus 8 when the display layout defining data for the table layout of FIG. 8 are read out.

FIG. 10 is a flow chart showing the display output processing executed by CPU 2 of FIG. 1.

FIG. 11 is a flow chart showing a graphic object subroutine called by the display output process of FIG. 10 and the print subroutine for the table data of FIG. 16.

FIG. 12 is a flow chart showing a subroutine in which the display cell address is converted into the worksheet calculation cell address by layout conversion processing unit 6 of FIG. 1.

FIG. 13 is a flowchart showing the screen input process executed by CPU 2 of FIG. 1.

FIG. 14 is a diagram showing how the table data of FIG. 2, which has display layout defining data for layout as shown in FIG. 4 in display apparatus 8 of FIG. 1, appear on a screen when the screen input process is executed.

FIG. 15 is a flow chart showing a journal output process executed by CPU 2 of FIG. 1.

FIG. 16 is a flow chart showing the first half print subroutine of the table data, called by the journal output process as shown in FIG. 15.

FIG. 17 is a flow chart showing the second half print subroutine of the table data, called by the journal output process as shown in FIG. 15.

FIG. 18 is a diagram showing how the table data of FIG. 2, having the display layout defining data of FIG. 4, layout in printer 9 of FIG. 1.

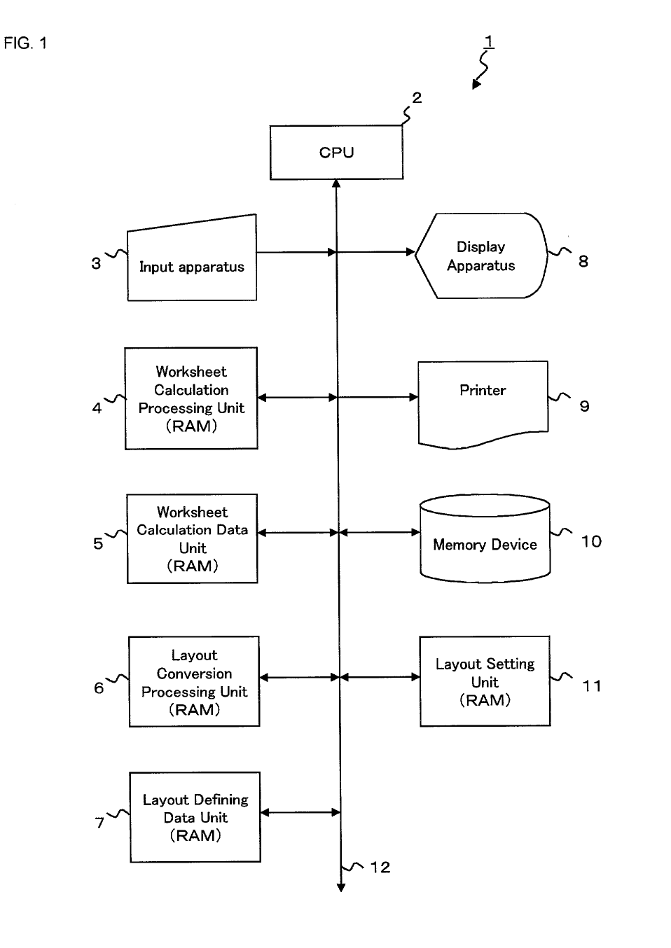

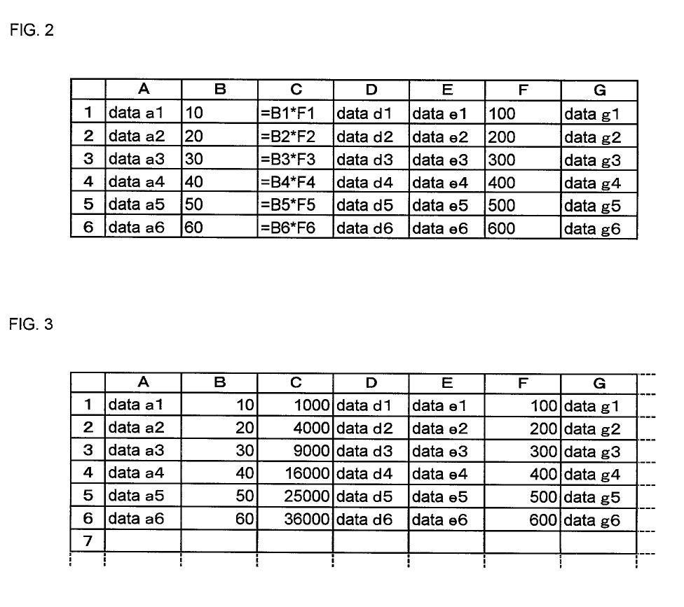

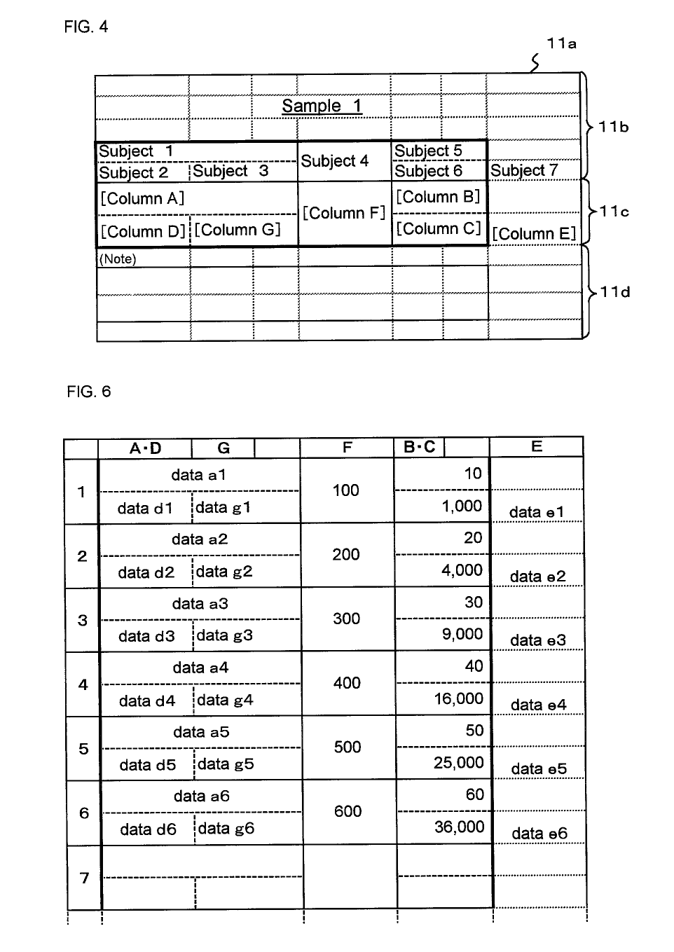

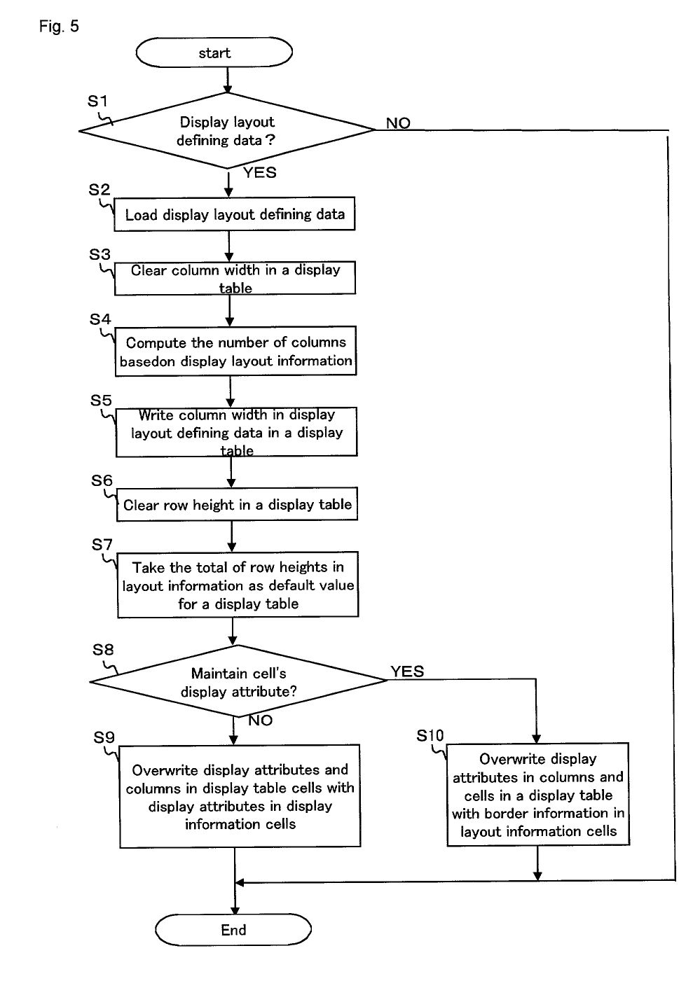

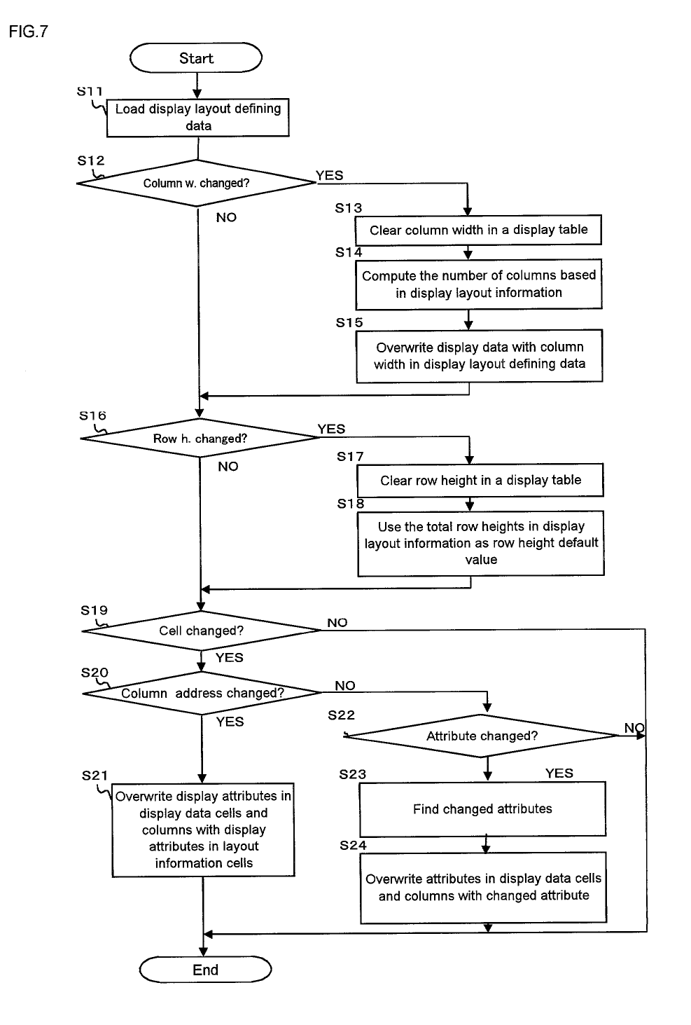

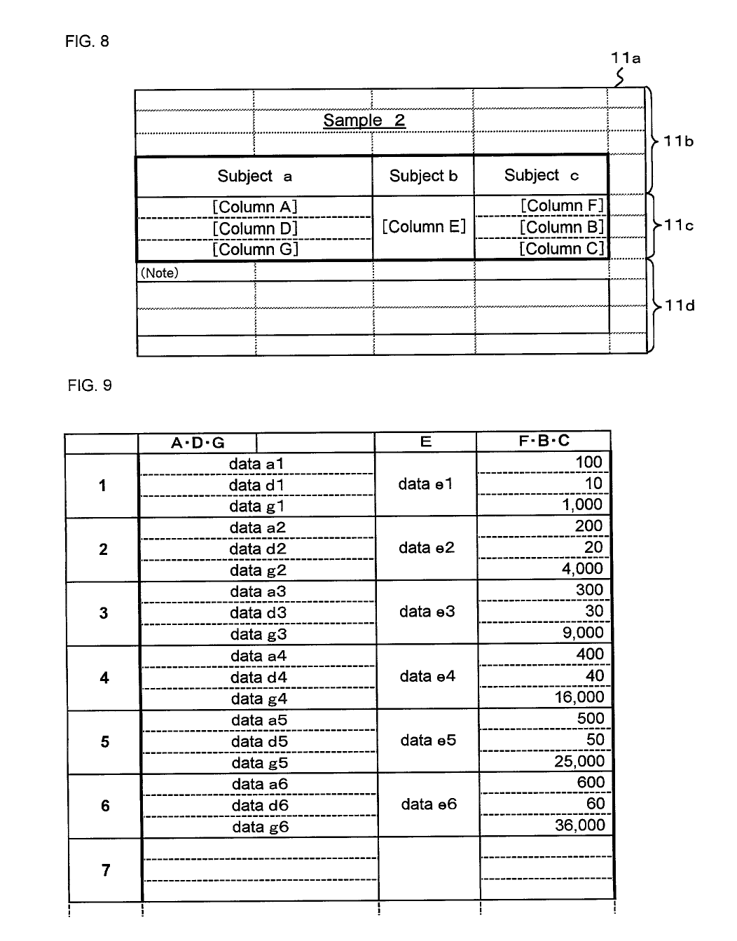

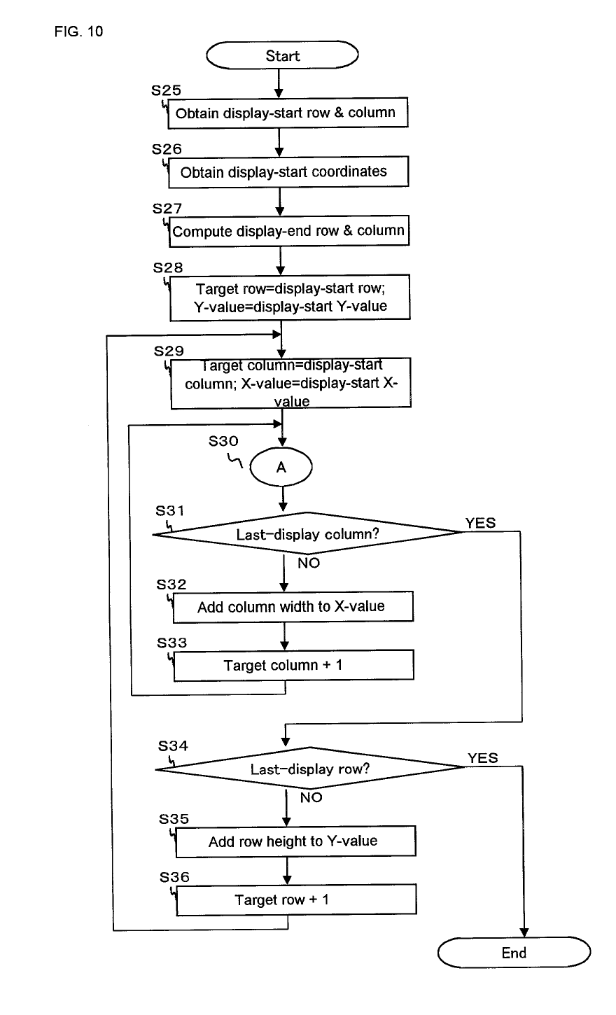

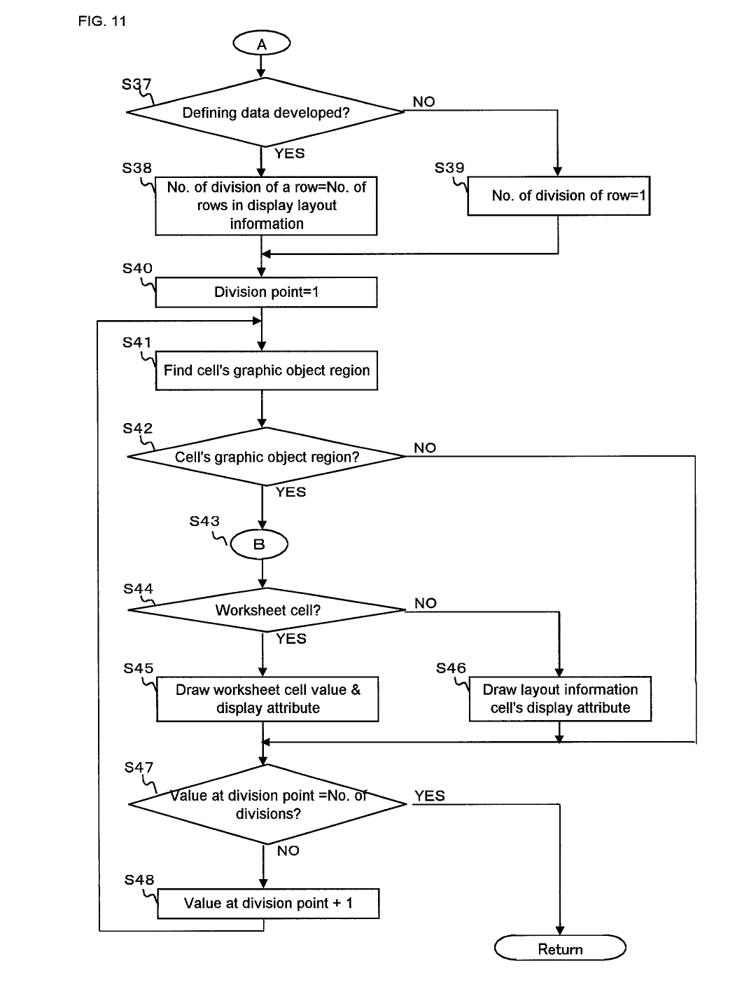

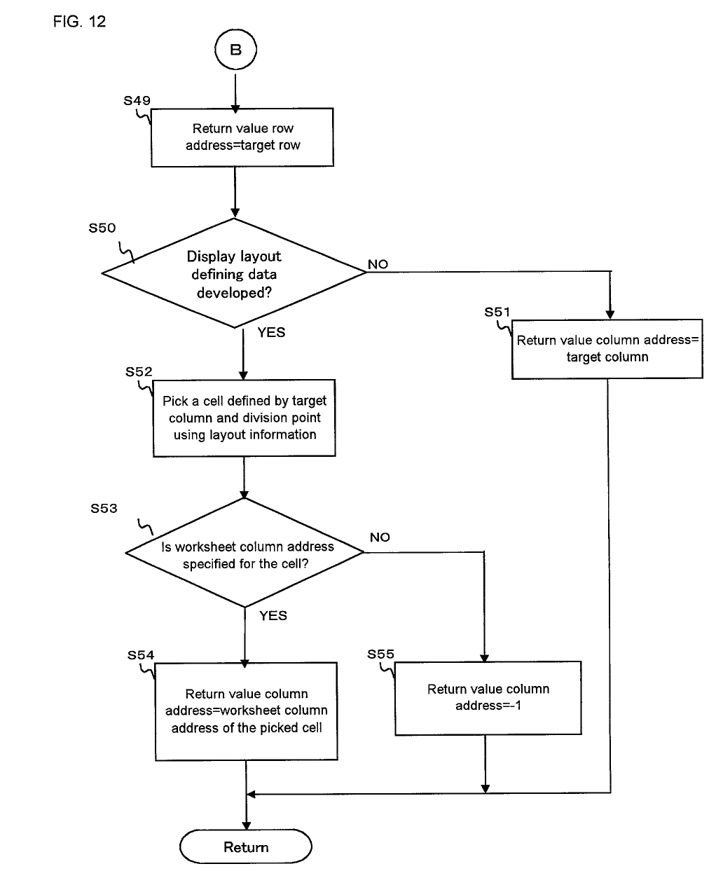

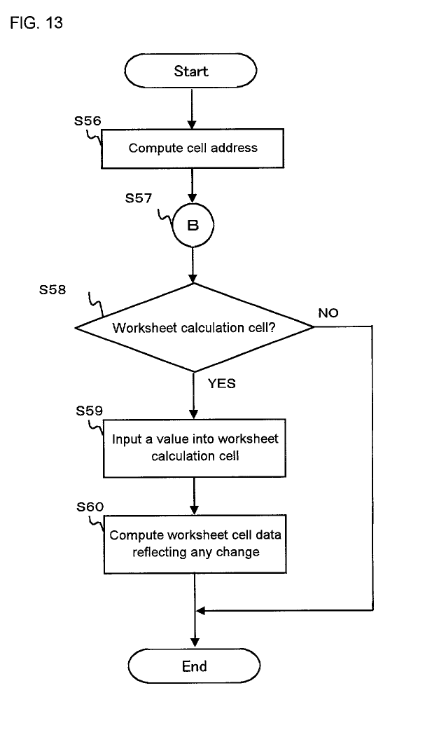

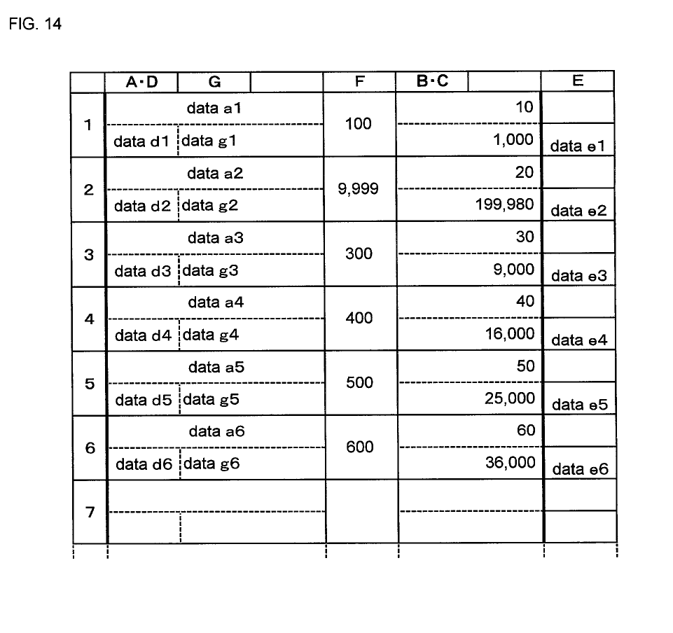

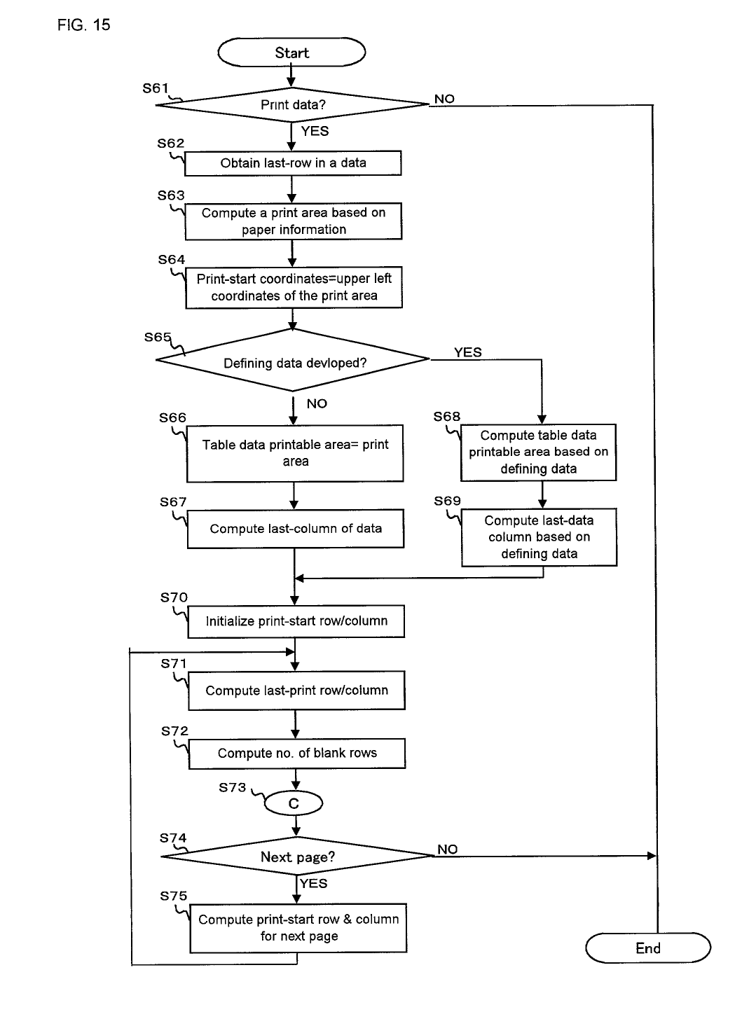

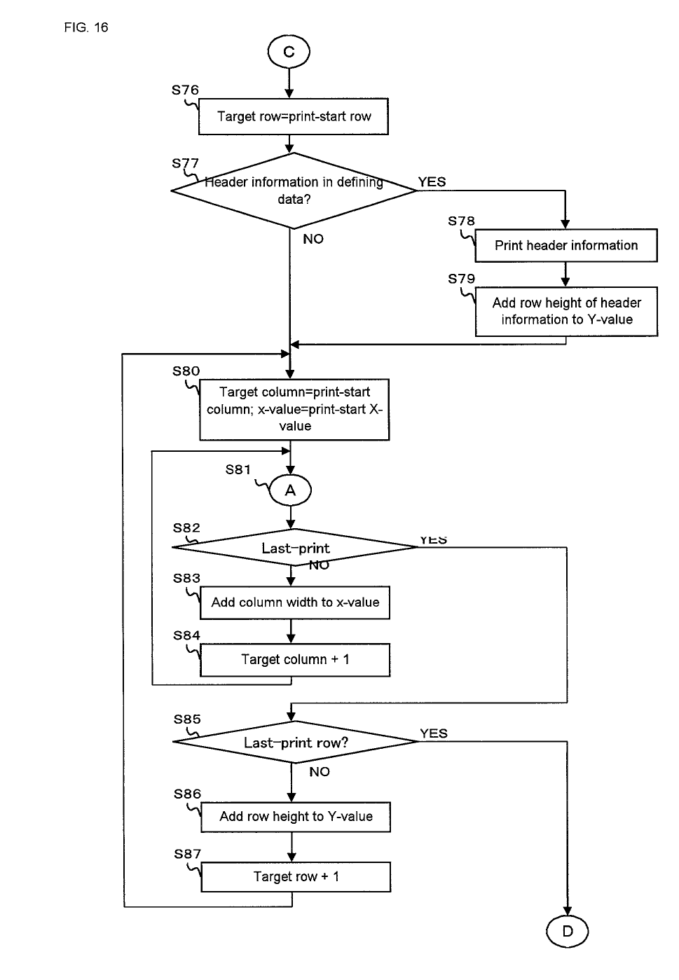

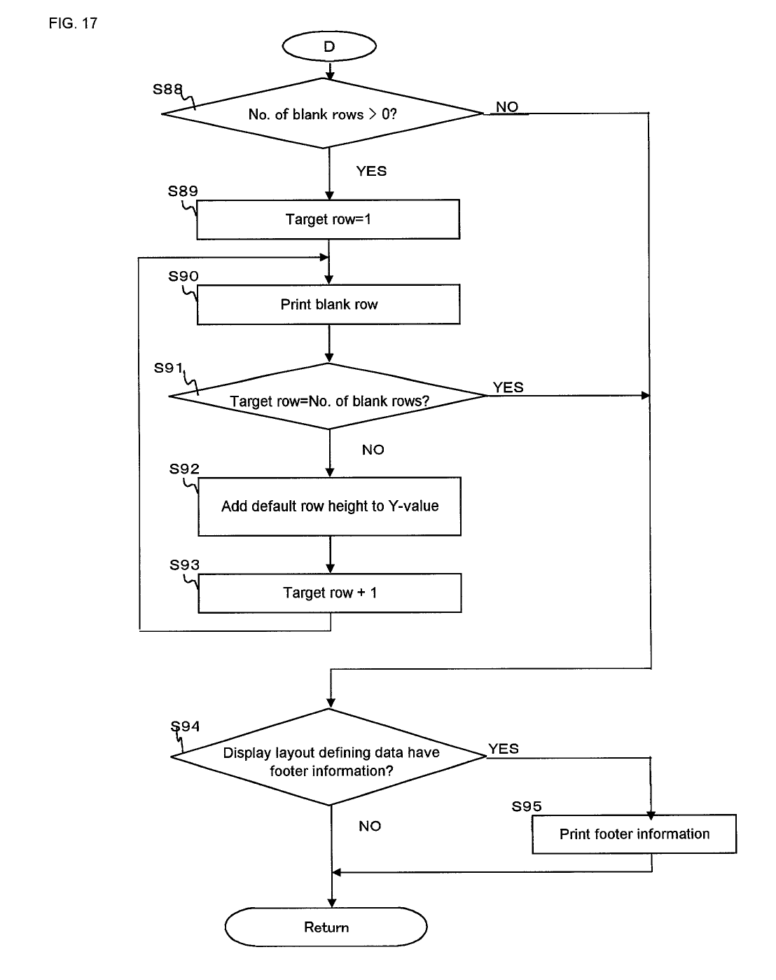

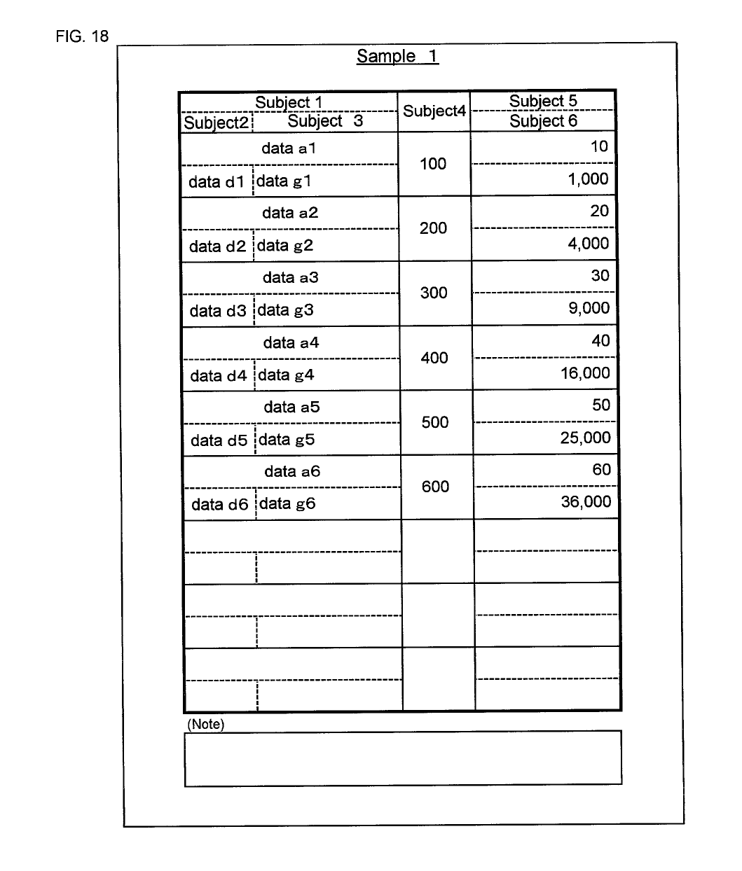

REFERENCE SYMBOLS

| 1 | computer system |
|---|---|
| 2 | CPU |
| 3 | input apparatus |
| 4 | worksheet calculation processing unit |
| 5 | worksheet calculation data unit |
| 6 | layout conversion processing unit |
| 7 | display layout defining data unit |
| 8 | display apparatus |
| 9 | printer |
| 10 | memory device |
| 11 | layout setting unit |
| 12 | bus |

| | |
|---|---|
| 5 | worksheet calculation data unit |
| 6 | layout conversion processing unit |
| 7 | display layout defining data unit |
| 8 | display apparatus |
| 9 | printer |
| 10 | memory device |
| 11 | layout setting unit |
| 12 | bus |

What is claimed is:

1. A process of inputting/outputting [a display table] derived from worksheet cells having formulas and display attributes by repeatedly developing worksheet column cells into rows of the display table based on previously-set layout information in display layout defining data [file] while maintaining the original formulas and attributes.

2. A process of outputting a journal [of a display table] derived from worksheet cells having formulas and display attributes by a printer by steps comprising:
adjusting header information in display layout defining data based on a command-entered paper size, printing orientation, and margins;
repeatedly developing the worksheet's column cells into rows in a printable region according to the layout information in the display layout defining data [file];
inserting blank rows, when the developed region is narrower than the layout information's printable region by executing a blank row-filling page set-up routine; and
arranging a footer defined by the display layout defining data.

3. A process of inputting/outputting a display table derived from a worksheet as set forth in claim 1 by changing the display layout defining data or display layout defining files, while maintaining the original formulas and attributes;
wherein the display layout defining data are created in a data table streamed in files comprising:
[display] layout information for defining worksheet's column cell addresses, display and print cell addresses, and display attributes; and
header and footer information for defining print page settings.

4. A process of outputting a journal of the display table by a printer as set forth in claim 2 by changing the display layout defining data or display layout defining files, while maintaining the original formulas and attributes;
wherein the display layout defining data are created in a data table streamed in files comprising:
[display] layout information for defining worksheet's column cell addresses, display and print cell addresses, and display attributes; and
header and footer information for defining print page settings.

5. A process of inputting/outputting display data derived from a worksheet as set forth in claim 1 by entering a command into a plurality of display data cells for changing column width, row height, and cells' display attributes;
wherein the display layout defining data default values are as follows:
column width defined by display layout defining data and
row height defined by layout information in display layout defining data.

6. A process of outputting a journal [of the display table] by a printer as set forth in claim 2 by entering a command into a plurality of display data cells for changing column width, row height, and cells' display attributes;
wherein the display layout defining data default values are as follows:
column width defined by display layout defining data and
row height defined by layout information in display layout defining data.
